(19) United States
(12) Patent Application Publication
(10) Pub. No.: US 2009/0151258 A1
(43) Pub. Date: Jun. 18, 2009

(54) Locking Mechanism for a Child Safety Barrier

(75) Inventor: Finn Andersen, Lasby (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: BABY DAN A/S

(21) Appl. No.: 12/084,573

(22) PCT Filed: Nov. 6, 2006
(86) PCT No.: PCT/DK2006/000610

§ 371 Date: Jul. 21, 2008

(30) Foreign Application Priority Data
Nov. 8, 2005 (DK) PA 2005 01541
Jun. 19, 2006 (DK) PA 2006 00828

(51) Int. Cl. E05B 53/00; E05B 47/06

(52) U.S. Cl. 49/281; 49/357

(57) ABSTRACT

A locking mechanism for a child safety barrier (1) may be activated by a foot pedal (6) which can only be operated when an auxiliary lock (8) has been activated. The auxiliary lock (8) is formed by a mechanical unit, which has an electrical receiver (8a) which, when receiving an electrical signal, e.g. an electromagnetic signal from a transmitter (9), can activate the auxiliary lock (8), following which the foot pedal (6) may be activated. The transmitter (9) may be incorporated in a remote control unit of the hand-held type, or it may be mounted on a wall, where an adult can activate the transmitter, e.g. by an elbow. The transmitter may also be a unit which continuously transmits electromagnetic signals which activate the auxiliary lock when they are interrupted.

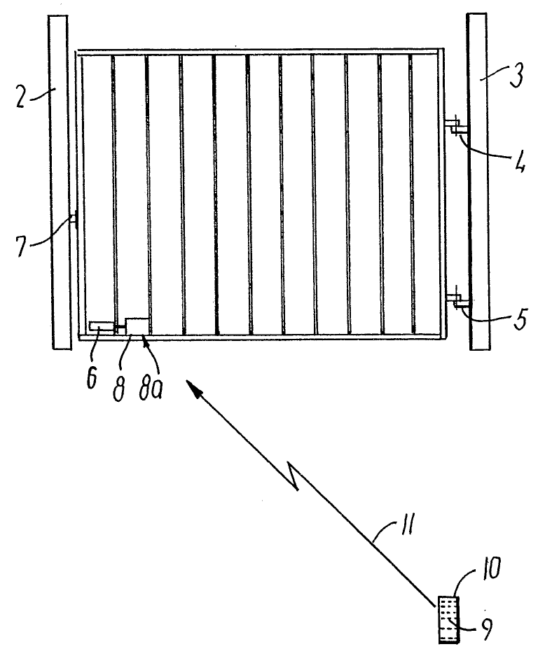

The invention relates to a locking mechanism with a lock for a child safety barrier, wherein the lock may be activated by a foot, and wherein the lock is locked by a mechanical auxiliary lock which ensures in a locked state that the foot cannot activate the lock.

U.S. Pat. No. 6,499,254 B2 discloses a lock which may be operated by a foot pedal which requires a force that is greater than the force which a normal child can provide.

Clearly, such a locking mechanism is to meet two purposes, one being that the force to be used for operating the foot pedal and opening the barrier must be sufficient to ensure that the strongest child cannot operate the foot pedal.

On the other hand, the force must not be so great either that some adults cannot operate the foot pedal or can only operate it with great difficulty.

Further, U.S. Pat. No. 5,217,265 discloses a child safety barrier with a foot-operable lock, where an extra lock which locks the foot-operable lock is arranged for reasons of safety. Both locks must be operated at the same time by use of a person's one hand and foot.

Accordingly, an object of the invention is to provide a locking mechanism which is safer and easier to operate.

The object of the invention is achieved by a locking mechanism of the type stated in the introductory portion of claim 1, which is characterized in that the mechanical lock may be activated by an electrical receiver, which unlocks the auxiliary lock when the receiver receives an electrical signal from a transmitter.

This ensures that it is impossible to open the child safety barrier without a signal being applied to the receiver, and that it is not necessary to use the hands to operate the mechanical lock.

A simple way of implementing the electrical signal is, as stated in claim 2, that the transmitter is adapted to transmit an electromagnetic signal, such as an infrared beam, to the receiver.

As stated in claim 3, this transmitter may be incorporated in a remote control unit, which, as stated in claim 4, may be of a hand-held type, or, as stated in claim 5, may be mounted on a wall.

When, as stated in claim 6, the transmitter continuously transmits electromagnetic signals to the receiver, and the auxiliary lock is activated when the electromagnetic signals are interrupted, an operation-free solution is achieved, where e.g. an adult does not have to do anything else, but approach the child safety barrier in order to activate the foot pedal.

To ensure that an adult does not forget to deactivate the auxiliary lock, it is an advantage, as stated in claim 7, that the foot pedal can only be activated during a given interval of time after the auxiliary lock has been activated.

The invention will now be explained more fully in connection with the sole FIGURE of the drawing.

In this drawing, the numeral 1 designates a child safety barrier with ribs, which is suspended from a post 1 by means of hinges 3, 4. The child safety barrier is locked to another post 2 via a locking pawl 7, which may be activated by a foot pedal 6.

This, however, can be activated only when an auxiliary lock, which is shown schematically in the FIGURE and is designated 8, is activated.

The auxiliary lock is mechanically connected with the foot pedal 6, e.g. by a pawl, which prevents the foot pedal 6 from being activated.

An electrical circuit in the form of a receiver is incorporated in the auxiliary lock 8, said receiver being adapted to transmit an electromagnetic signal 11 when it has received an electrical signal from a transmitter, shown here as a remote control unit 9.

The remote control unit may be a hand-held unit with operating buttons 10, but it might equally well be a fixed unit which was mounted on a wall and activatable by an elbow. The condition is just that a child cannot reach and operate the fixed unit.

Finally, the transmitter may be constructed as a transmitter which transmits an electromagnetic beam which is continuously transmitted to the electrical receiver or is transmitted to a separate, electrical receiver. When the beam is interrupted, if an adult passes and thus interrupts the beam, the electrical receiver will activate the auxiliary lock.

If a separate, electrical receiver is used, it will enter into a transmit mode which activates the electrical receiver, when the beam is interrupted.

1. A child safety barrier (1) with a lock arrangement comprising a lock that may be activated by a foot, and wherein the lock is locked and unlocked by a mechanical auxiliary lock (8) which ensures in a locked state that the foot cannot activate the lock, wherein the foot pedal can be activated during a given interval of time after the mechanical auxiliary lock has been unlocked.

2. A child safety barrier according to claim 1, wherein the mechanical auxiliary lock may be unlocked by an electrical receiver (8a), when the receiver receives an electrical signal from a transmitter (9).

3. A child safety barrier according to claim 2, wherein the transmitter (9) is adapted to transmit an electromagnetic signal, such as an infrared beam to the receiver.

4. A child safety barrier according to claim 3, wherein the transmitter (9) is incorporated in a remote control unit.

5. A child safety barrier according to claim 4, wherein the remote control unit is of the hand-held type.

6. A child safety barrier according to claim 4, wherein the remote control unit is mounted on a wall.

7. A child safety barrier according to claim 6, wherein the transmitter continuously transmits electromagnetic signals to the receiver, and the auxiliary lock (8) is activated when the electromagnetic signals are interrupted.
